(19) United States
(12) Patent Application Publication
(10) Pub. No.: US 2009/0131001 A1
(43) Pub. Date: May 21, 2009

(54) SWITCH ARCHITECTURE

(76) Inventor: James Breslin, Cork (IE)

Correspondence Address: Tyco Technology Resources;Suite 140, 4550 New Linden Hill Road, Wilmington, DE, 19808-2952, US

(21) Appl. No.: 11/941,577

(22) Filed: Nov. 16, 2007

(51) Int. Cl. H04B 1/18

(52) U.S. Cl. 455/150.1

(57) ABSTRACT

An apparatus may include a filtering network and a switch. From an amplified signal, the filtering network produces a filtered signal for wireless transmission in a frequency band. The switch includes a first terminal, a second terminal, and a switching element. The first terminal receives the filtered signal and the switching element selectively couples the first and second terminals. The filtering network also attenuates harmonics of the filtered signal that are generated by the switch. This attenuation establishes compliance with a harmonic emissions power limit associated with the frequency band. More particularly, this attenuation reduces at least one of the harmonics from a level exceeding the harmonic emissions power limit to a level within the harmonic emissions power limit.

### BACKGROUND

Wireless devices, such as mobile telephone handsets, may transmit and receive signals at various frequency bands. To provide this capability, wireless devices may include switches. For example, a device may include a high power switch to selectively provide an antenna with amplified signals in different frequency bands.

In practice, such switches are conventionally designed as individual components for a generic application, (e.g., cellular telephony). In other words, such switches are not typically designed for a particular device or circuit context. Therefore, according to this generic approach, switches are often designed to surpass an application's specified transmission power requirements by an excessive margin. For instance, switches for cellular handset applications are often designed to have 1 dB compression points that are greater than 6 dB above the specified cellular transmit power requirements.

Unfortunately, this design approach increases the cost and size of switches.

### SUMMARY

The present invention provides various embodiments that may involve the switching of radio frequency (RF) signals. For instance, an apparatus may include a filtering network and a switch. From an amplified signal, the filtering network produces a filtered signal for wireless transmission in a frequency band. The switch includes a first terminal, a second terminal, and a switching element. The first terminal receives the filtered signal and the switching element selectively couples the first and second terminals. The filtering network also attenuates harmonics of the filtered signal that are generated by the switch. This attenuation establishes compliance with a harmonic emissions power limit associated with the frequency band. For instance, this attenuation may reduce at least one of the harmonics from a level exceeding the harmonic emissions power limit to a level within the harmonic emissions power limit.

The switching element may include with various devices, such as one or more transistors (e.g., one or more field effect transistors (FETs)), one or more diodes (e.g., one or more PIN diodes, one or more electromechanical devices, and so forth. Thus, the embodiments are not limited to these examples.

A further apparatus may include a first filtering network, a second filtering network, an antenna, and a switch. From a first amplified signal, the first filtering network produces a first filtered signal for wireless transmission in a first frequency band. Also, from a second amplified signal, the second filtering network produces a second filtered signal for wireless transmission in a second frequency band. The switch selectively provides the first filtered signal to the antenna, and selectively provides the second filtered signal to the antenna.

Also, the first and second filtering networks attenuate harmonics of the first and second filtered signals that are generated by the switch. For instance, the first filtering network attenuates harmonics of the first filtered signal to establish compliance with a harmonic emissions power limit associated with the first frequency band. Similarly, the second filtering network attenuates harmonics of the second filtered signal to establish compliance with a harmonic emissions power limit associated with the second frequency band.

### BRIEF DESCRIPTION OF THE DRAWINGS

FIG. 1 illustrates an exemplary apparatus;

FIG. 2 is a schematic of an exemplary switch;

FIG. 3 illustrates an exemplary framework for filtering networks;

FIG. 4 is a graph showing harmonic characteristics of a switch;

FIGS. 5A and 5B diagrams of arrangements for evaluation;

FIGS. 6-9 are graphs showing performance characteristics across a range of frequencies; and

FIG. 10 is a frequency response graph of a filtering network.

### DETAILED DESCRIPTION

Various embodiments may involve switches. Such switches may be employed in the transmission and/or reception of radio frequency (RF) signals. Moreover, such switches may be structured to cover a wide range of frequencies. For instance, in embodiments, switches may be used for multi-band (e.g., quad-band) cellular operation.

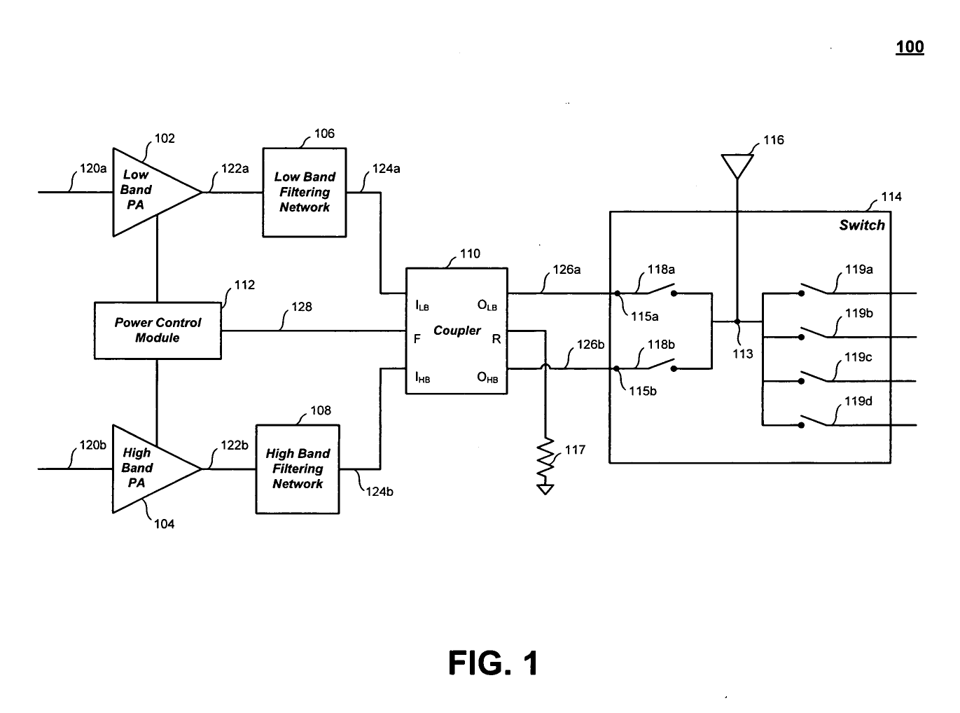

FIG. 1 illustrates an arrangement that employs a switch. In particular, FIG. 1 is a diagram of a transmit module 100 that may be included in various devices and/or systems. For instance, transmit module 100 may be included in a mobile telephone (e.g., a GSM/EDGE phone and/or PCS phone). The embodiments, however, are not limited to such devices or systems.

Transmit module 100 may include various elements. For instance, FIG. 1 shows that transmit module 100 may include a low band power amplifier (PA) 102, a high band PA 104, a low band filtering network 106, a high band filtering network 108, a coupler 110, a power control module 112, a switch 114, and an antenna 116. These elements may be implemented in hardware, software, firmware, or in any combination thereof.

Transmit module 100 may operate in various frequency bands. For instance, transmit module 100 may be GSM/EDGE quad-band capable. That is, transmit module 100 may operate in the GSM850 band from 824 MHz to 849 MHz, the EGSM900 band from 880 MHz to 915 MHz, the European DCS band from 1710 MHz to 1785 MHz and the PCS band from 1850 MHz to 1910 MHz. The embodiments, however, are not limited to operation in these frequency bands.

Low band PA 102 receives a low band signal 120a (such as a GSM850 band signal and/or an EGSM900 band signal) and produces a corresponding amplified low band signal 122a. Similarly, high band PA 104 receives a high band signal 120b (such as a European DCS band signal and/or a PCS band signal) and produces a corresponding amplified high band signal 122b.

In embodiments, only one of signals 120a and 120b are provided at a particular time. This may be based, for example, on the type of communications network being accessed. However, the embodiments are not so limited. For instance, certain embodiments may provide signals 120a and 120b simultaneously.

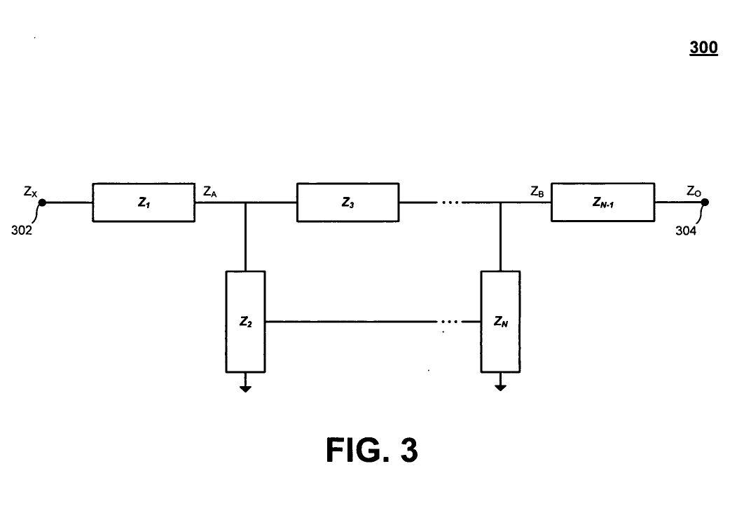

Signals 122a and 122b are sent to filtering networks 106 and 108, respectively. These filtering networks provide impedance matching for PAs 102 and 104. Additionally, these networks filter harmonics from signals 122a and 122b. As shown in FIG. 1, filtering networks 106 and 108 produce filtered signals 124a and 124b, respectively. Details regarding exemplary implementations of these networks are provided below with reference to FIG. 3.

As shown in FIG. 1, coupler 110 includes a low band input port (I_{LB}), a low band transmitted port (O_{LB}), a high band input port (I_{HB}), a high band transmitted port (O_{HB}), a coupled port (F), and an isolated port (R). Input ports I_{LB} and I_{HB} receive filtered signals 124a and 124b, respectively. In turn, FIG. 1 shows that transmitted ports O_{LB} and O_{HB} pass these signals to switch 114 as filtered signals 126a and 126b.

FIG. 1 further shows that coupled port (F) of coupler 110 produces a feedback signal 128. Through this arrangement, feedback signal 128 may have characteristics (such as power level and frequency) that correspond to signals 124a and/or 124b. Feedback signal 128 is sent to power control module 112.

Isolated port R of coupler 110 is terminated to ground through a resistance 117. This resistance may be matched to the characteristic impedance (e.g., 50 Ohms) associated with the corresponding coupler's isolated port. Although resistance 117 is shown as being separate from coupler 110, it may alternatively be included in coupler 110.

Based on feedback signal 128, power control module 112 may perform power control operations. Such operations may involve controlling parameters or settings (e.g., bias point and/or gain) of PA 102 and/or PA 104. Accordingly, FIG. 1 shows that power control module 112 is connected to both PA 102 and PA 104.

As described above, coupler 110 receives filtered signals 124a and 124b, and provides switch 114 with corresponding filtered signals 126a and 126b. Based on its setting, switch 114 may selectively forward these signals to antenna 116 for wireless transmission. For example, switch 114 may forward either signal 126a or 126b to antenna 116. Further, in embodiments, switch 114 may selectively forward both of these signals to antenna 116.

As shown in FIG. 1, switch 114 includes transmit arms 118a and 1118b. Transmit arm 118a receives filtered signal 126a at an input terminal 115a and provides this signal to a common terminal 113 (thus, connecting terminals 115a and 113). Similarly, transmit arm 118b receives signal 126b at an input terminal 115b and provides this signal to common terminal 113 (thus, connecting terminals 115b and 113). Further, switch 114 includes receive arms 119a-d. These receive arms may selectively forward wireless signals received at common terminal 113 (e.g., from antenna 116) to corresponding receiver components (not shown). As shown in FIG. 1, common terminal 113 is connected to antenna 116.

In quad-band capable embodiments, each of receive arms 119a-d may correspond to a particular band. For instance, receive arm 119a may correspond to the GSM850 band, receive arm 119b may correspond to the EGSM900 band, receive arm 119c may correspond to the European DCS band, and receive arm 119d may correspond to the PCS band. The embodiments, however, are not limited to this arrangement.

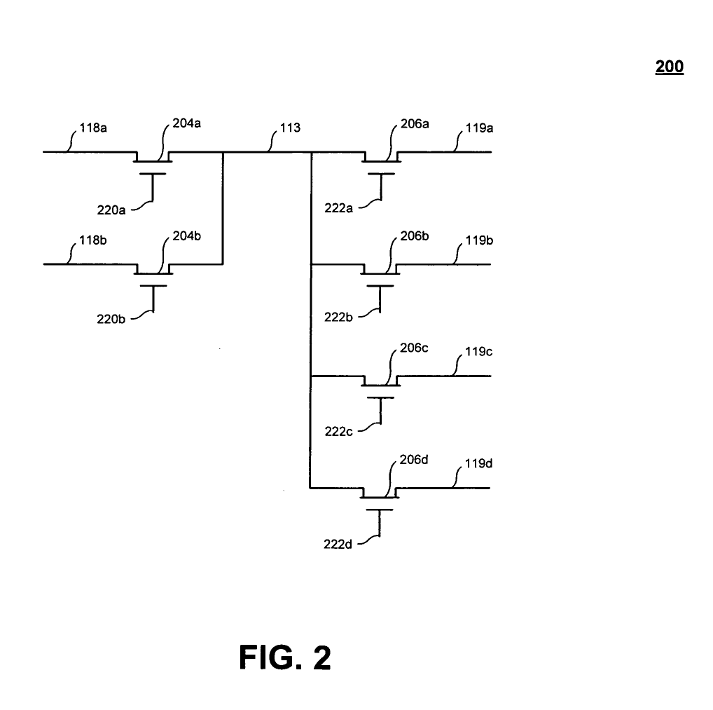

Thus, each of transmit arms 118a-b and receive arms 119a-d may be in an ON state that provides a connection with common terminal 113 (and thus with antenna 116), and an OFF state that provides isolation (e.g., a disconnection) from common terminal 113. These states are determined through control signals, which are described in greater detail below with reference to FIG. 2.

As discussed above, component size and cost is important in the design and manufacturing of user devices. To this end, embodiments may exhibit suitable performance characteristics (such as suitable compression points), while employing switches that are smaller and less expensive.

In general operation, when a transmit arm within switch 114 is in an ON state (i.e., when it provides a connection to antenna 116), harmonics generated in the transmit arm receive the same termination as the corresponding power amplifier. More particularly, when transmit arm 118a is in an ON state, it (as well as PA 102) is terminated by network 106. Similarly, when transmit arm 118b is in an ON state, it (as well as PA 104) is terminated by network 108.

Thus, networks 106 and 108 also attenuate harmonics generated by switch 114. Through this feature, switch 114 may be implemented according to constraints that are less stringent than those applied to conventional switches designed in isolation of their eventual implementation context. This attenuation may establish compliance with a specified harmonic emissions power limit (e.g., −35 dBm) that is associated with one or more frequency bands (e.g., required by one or more cellular networks). For instance, this attenuation may reduce at least one harmonic generated by switch 114 from a level exceeding the harmonic emissions power limit to a level within the harmonic emissions power limit.

The arrangement of FIG. 1 is provided for purposes of illustration, and not limitation. Accordingly, other arrangements (as well as variations of the illustrated arrangement) are within the scope of the present invention. For example, arrangements may include other components, as well as omit one or more of the illustrated components. The embodiments are not so limited.

FIG. 2 is a schematic showing an exemplary implementation 200 of switch 114. This implementation, however, is not limited to the context of FIG. 1. FIG. 2 shows that implementation 200 includes common terminal 113. As described above, common terminal 113 may be connected to antenna 116.

Each of transmit arms 118a-b and each of receive arms 119a-d may include one or more peripheries. For instance, FIG. 2 shows that each of transmit arms 118a-b and each of receive arms 119a-d includes a switching element. In particular, FIG. 2 shows each of these arms including a field effect transistor (FET) switching device. More particularly, FIG. 2 shows transmit arm 118a having a FET switching device 204a, and transmit arm 118b having a FET switching device 204b. Similarly, FIG. 2 shows receive arm 119a having a FET switching device 206a, receive arm 119b having a FET switching device 206b, receive arm 119c having a FET switching device 206c, and receive arm 119d having a FET switching device 206d.

Switching devices 204a-b and 206a-d may be implemented in various ways. For example, one or more of these devices may be implemented as single gate, single channel devices. Alternatively, one or more of these devices may be implemented as multiple gate and/or multiple channel devices. For instance, one or more of these devices may be implemented as multiple FETs arranged in series or as multiple gate devices.

Further, FET switching devices 210a-b and 212a-d may each be implemented with a Gallium Arsenide (GaAs) process. Such a process may be a pseudomorphic High Electron Mobility Transistor (PHEMT) GaAs process. The embodiments, however, are not limited to such implementations.

FIG. 2 shows that each of FET switching devices 204a-b and 206a-d receives a control signal at its gate terminal. For instance, switching device 204a receives a control signal 220a and switching device 204b receives a control signal 220b. Similarly, switching device 206a receives a control signal 222a, switching device 206b receives a control signal 222b, switching device 206c receives a control signal 222c, and switching device 206d receives a control signal 222d. In implementations where one or more of switching devices 204a-b and/or 206a-d include multiple gate terminals, the corresponding control signals may be sent to each of such multiple gate terminals. Control signals 220a-b and 222a-d are employed to select whether the corresponding transmit and receive arms are in an ON state or an OFF state.

The implementation of FIG. 2 is shown for purposes of illustration, and not limitation. Thus, switching modules may be implemented in other ways. For instance, switching module implementations may employ switching elements that include devices other than FETs. Examples of such devices include PIN diodes (as well as other types of diodes), silicon on insulator (SOI) complementary metal oxide semiconductor (CMOS) transistors, electromechanical devices (e.g., microelectromechanical systems (MEMS) devices), and so forth. Thus, the embodiments are not limited to these examples.

As described above, switches are typically designed as individual components without concern for a particular implementation context or circuit. Thus, switches are conventionally designed to exceed performance requirements of an application (e.g., cellular telephony). Such performance requirements include maximum transmit power limits established by organizations, such as the European Telecommunications Standards Institute (ETSI). For instance, exemplary maximum transmit power limits specified for mobile devices are 34 dBm for the GSM850 and EGSM900 bands, and 32 dBm for the PCS and European DCS bands.

In addition, such organizations specify power limits for harmonic emissions. For instance, a typical specified requirement is that harmonic emissions must be less than −35 dBm. Thus, organizations specify that such power limits for harmonic emissions must be satisfied even at specified maximum transmit power levels.

To ensure that such harmonic emissions requirements are met, conventional switch designs for handset applications have 1 dB compression points that are greater than 6 dB above the typical maximum transmit power limits. Thus, with reference to the exemplary maximum transmit power limits provided above, such 6 dB margins would dictate a 1 dB compression point at 40 dBm for the GSM850 and EGSM900 bands, and a 1 dB compression point at 38 dBm for the PCS and European DCS bands.

However, switches may implement their transmit arms in the same manner. For instance, each transmit arm within such switches may provide 1 dB compression points at the greatest of these 6 dB margins. Thus, with reference to the exemplary maximum transmit power limits provided above, conventional switches may have 1 dB compression points at 40 dBm for the GSM850, EGSM900, PCS, and European DCS bands.

In contrast with the conventional approach described above, embodiments may employ switches having reduced linearity characteristics. For instance, embodiments may employ lower compression point margins. For example, embodiments may employ 1 dB compression points that are less than 6 dB above specified transmit power limits. However, embodiments may employ compression point margins at any levels that are suitable. For instance, for 1 dB compression points, embodiments may employ 5 dB margins, 4 dB margins, and/or 3 dB margins, as well as and any other suitable margins. Thus, the embodiments are not limited to these examples.

Accordingly, when employing a 3 dB margin, a switch (such as switch 114) may have a 1 dB compression point at 37 dBm for the GSM850 and EGSM900 bands, and a 1 dB compression point at 35 dBm for the PCS and European DCS bands. The embodiments, however, are not limited to such 3 dB margins.

Also, embodiments may provide compression points (such as 1 dB compression points) at the same power level for multiple bands. For example, switches may implement their transmit arms in the same manner and provide 1 dB compression points at the greatest of these 3 dB margins. Thus, using the above examples of specified maximum transmit power limits, switch 114 may have a 1 dB compression point at 37 dBm for the GSM850, EGSM900, PCS, and European DCS bands.

Thus, in the exemplary context of FIG. 1, switch 114 may exhibit reduced linearity in comparison with conventional switches. In turn, such reduced linearity may allow for reduced periphery sizes within switch 114.

Referring again to FIG. 2, embodiments may reduce the size of FET switching devices 204a-b by approximately 30 percent from the size of typical FET implementations. Also in embodiments, FET switching devices 206a-d (in receive arms 119a-d) may be reduced by approximately 20 percent from the size of typical FET implementations.

Such size reductions for FET switching devices 206a-d (in receive arms 119a-d) may be achieved due to operational characteristics of switch 114. In particular, when one or more transmit arms 118a-b are in an ON state, embodiments set all of receive arms 119a-d in an OFF state. Conventionally, FET switching devices 206a-d are employed with multiple gates or devices to prevent transmit arms 118a-b from turning on FET switching devices 206a-d through a voltage change (e.g., a change in a DC operating point) of common terminal 113. Since switching devices 204a-b are reduced in size, such effects may be reduced. Therefore, the number of gates or devices needed to implement FET switching devices 206a-d may likewise be reduced.

As described above, the FETs employed as switching elements 204a-b and 206a-d may be implemented in accordance with a pHEMT GaAs process. A conventional switch for quad-band operation may employ approximately 3 millimeter (mm) pHEMT GaAs FETs for switching elements 204a-b and approximately 2 mm pHEMT GaAs FETs for switching elements 206a-d. However, in accordance with the size reductions described above, embodiments may employ 2.1 mm pHEMT GaAs FETs for switching elements 204a-b and 1.6 mm pHEMT GaAs FETs for switching elements 206a-d.

FIG. 3 is a diagram showing an exemplary filtering network framework 300. This framework may be employed to implement both low band filtering network 106 and high band filtering network 108, with each implementation may have its own respective characteristics.

Framework 300 includes multiple elements. For instance, FIG. 3 shows this framework having N elements (Z₁ through Z_{N}). Each of these elements may include an LC resonator network having either a series or a parallel resonance. Thus, elements Z₁ through Z_{N} may each include inductive and/or capacitive components. These components may be implemented in various ways, such as with surface mount or distributed components. The embodiments, however, are not limited to these examples.

Framework 300 includes an input node 302 and an output node 304. FIG. 3 further shows a PA output impedance Z_{X} at input node 302, and a system characteristic impedance Z_{O} at output node 304. Additionally, FIG. 3 shows intermediate impedances Z_{A} and Z_{B} between Z_{X} and Z_{O}.

Each of elements Z₁ through Z_{N} may perform two operations. First, each of these elements may perform harmonic filtering. Second, each of these elements may perform an impedance transformation function. Thus, in general operation, framework 300 transforms impedance Z_{X} to Z_{O}, while also filtering out harmonic frequencies produced by a PA connected to input node 302 (e.g., low band PA 102 or high band PA 104).

As described above, framework 300 may be used to implement both low band filtering network 106 and high band filtering network 108. However, each of these implementations may include respective characteristics. For example, the number of elements, N, may be different for each implementation. Further, the characteristics and parameters of the individual elements Z₁ through Z_{N} may be different for each implementation.

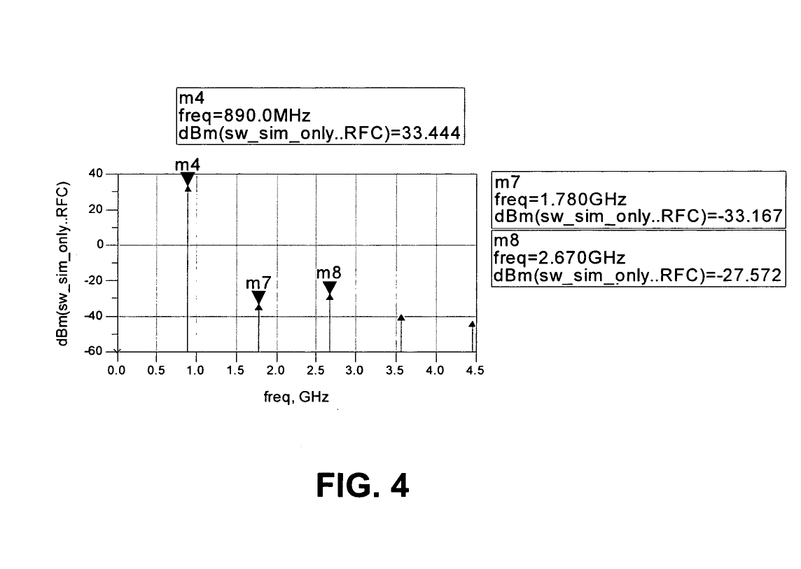

As described above, switches are conventionally designed in a generic manner without consideration for their ultimate circuit implementation. Thus, switch performance is typically evaluated in isolation of other elements. FIG. 4 provides an example of such an evaluation.

In particular, FIG. 4 is a graph showing output characteristics of a switch by itself (i.e., only terminated by a 50 Ohm impedance at its output terminal) when it receives an 890.0 MHz single frequency sinusoidal input signal at 34 dBm and passes it to its output terminal. Thus, in the context of FIG. 2, this signal may be received by transmit arm 118a and passed through switching device 204a to common terminal 113. The characteristics shown in FIG. 4 were obtained through computer simulation.

As shown in FIG. 4, the output signal at the fundamental frequency (890.0 MHz) has a power of 33.444 dBm. Moreover, the simulated switch produces several harmonics. These include a first harmonic at 1.780 GHz having a power level of −33.167 dBm and a second harmonic at 2.670 GHz having a power level of −27.572 dBm. Further, FIG. 4 shows the simulated switch producing a third harmonic at 3.560 GHz having a power level of approximately −40 dBm.

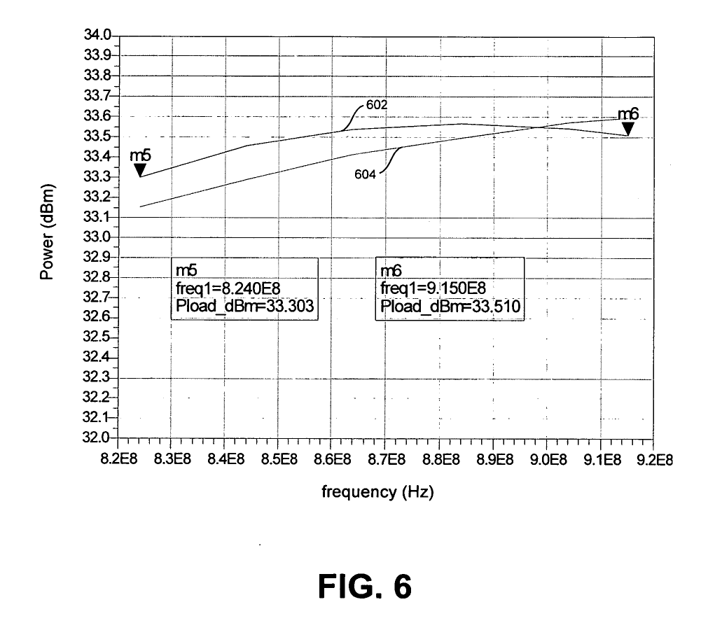

Conventionally, for quad-band cellular handset applications, a switch exhibiting the performance characteristics shown in FIG. 4 would be considered unacceptable. This is because every harmonic power level is not below a conventional threshold of −35 dBm. However, as described below with reference to FIGS. 6-9, this switch provides acceptable results within an implementation context, such as the transmit module of FIG. 1.

FIGS. 6-9 are graphs showing power levels across a range of frequencies. More particularly, each of these graphs includes two curves: a first curve corresponding to a first arrangement of elements, and a second curve corresponding to a second arrangement of elements. These curves were generated through computer simulations of these arrangements.

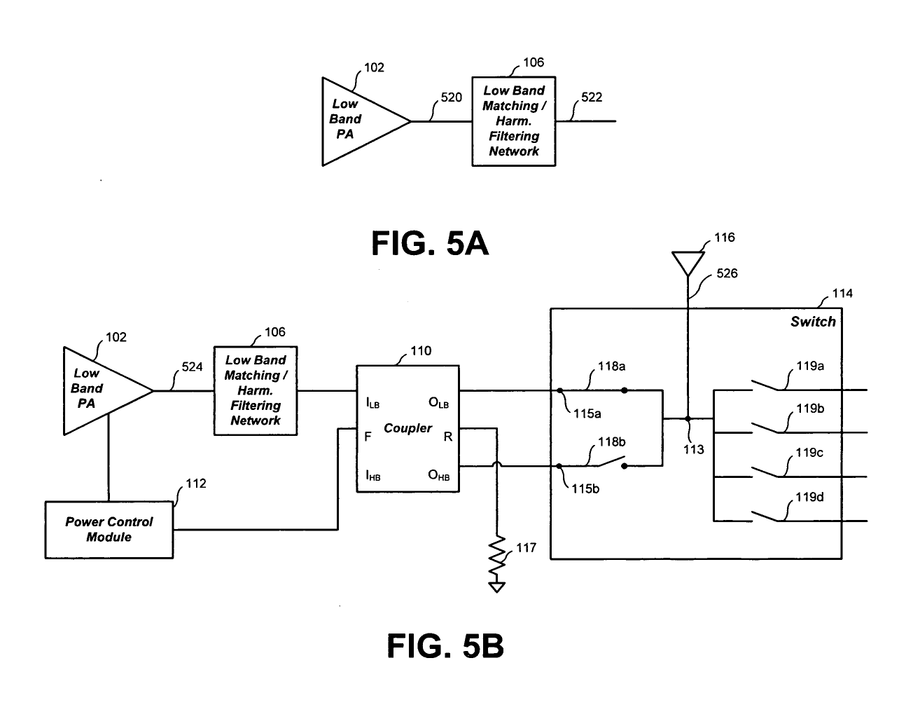

The first arrangement, which is shown in FIG. 5A includes low band PA 102 and network 106. In this arrangement, low band PA 102 produces a signal 520, which is a single frequency sinusoidal signal. From this signal, network 106 generates a signal 522.

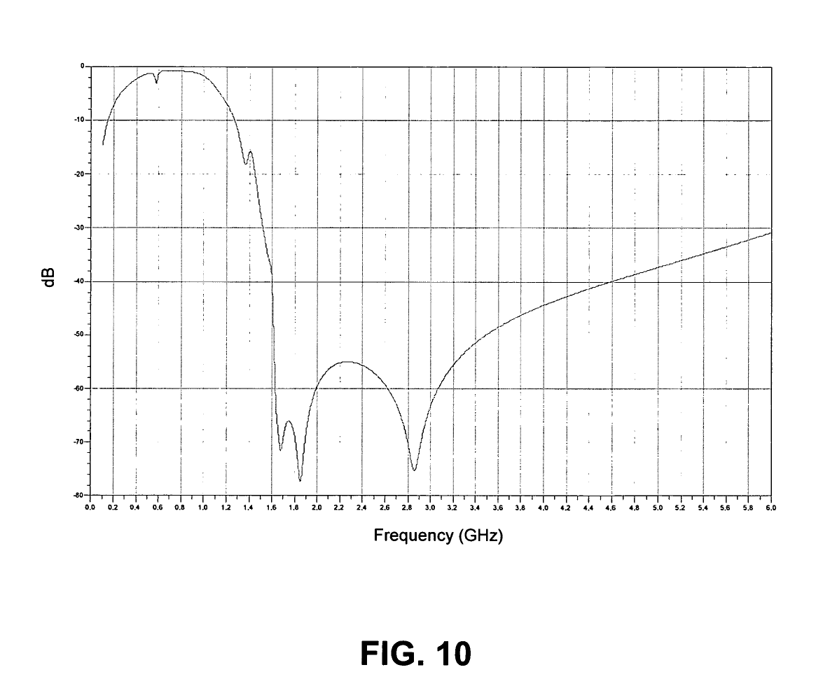

The second arrangement, which is shown in FIG. 5B, includes the low band transmission path of FIG. 1 with transmit arm 118a in an ON state. Thus, this arrangement includes low band PA 102, network 106, coupler 110, switch 114 (having the characteristics of FIG. 4), and antenna 116. In this arrangement, low band PA 102 generates a signal 524 (which is a single frequency sinusoidal signal), and a signal 526 is output by switch 114. Also, in this arrangement, power control module 112 does not perform any power adjustments to PAs 102 and 104. In the arrangement of FIG. 5B, coupler 110 provides an insertion loss of approximately 0.1 dB. Also, in this arrangement, the frequency response for network 106 is shown in FIG. 10.

FIG. 6 is a graph showing output power characteristics across a range of input frequencies. In particular, the graph of FIG. 6 includes a curve 602 showing fundamental frequency output power for signal 522 of FIG. 5A when signal 520 (its single frequency being varied across the graph's frequency range) has a power level of approximately 34 dBm. Further, the graph of FIG. 6 includes a curve 604 showing fundamental frequency output power for signal 526 of FIG. 5B when signal 524 (its single frequency being varied across the graph's frequency range) similarly has a power level of approximately 34 dBm.

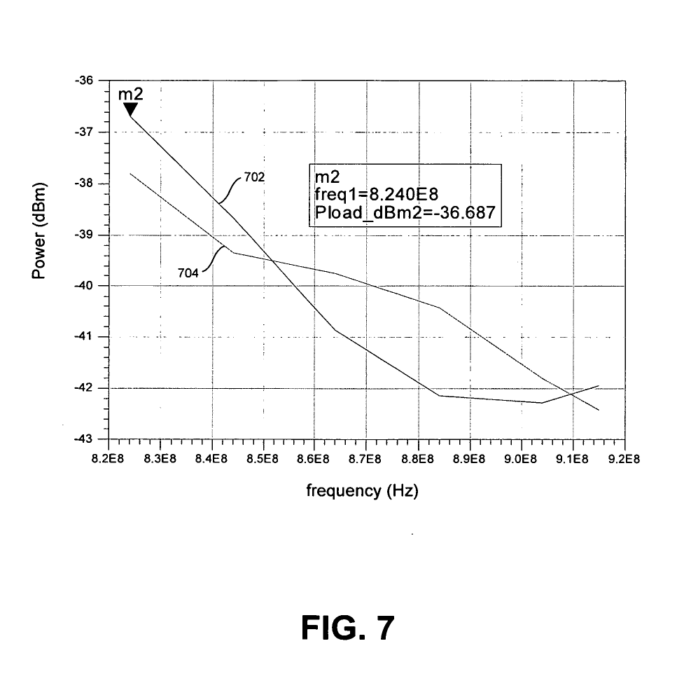

FIG. 7 is a graph showing first harmonic output power across a range of frequencies. In particular, the graph of FIG. 7 includes curves 702 and 704. Curve 702 shows first harmonic output power for signal 522 of FIG. 5A when signal 520 has a power level of approximately 34 dBm. In contrast, curve 704 shows first harmonic output power for signal 526 of FIG. 5B when signal 524 has a power level of approximately 34 dBm. As shown in FIG. 7, curve 704 provides first harmonic levels below −37 dBm, which is an improvement over the isolated switch results of FIG. 4.

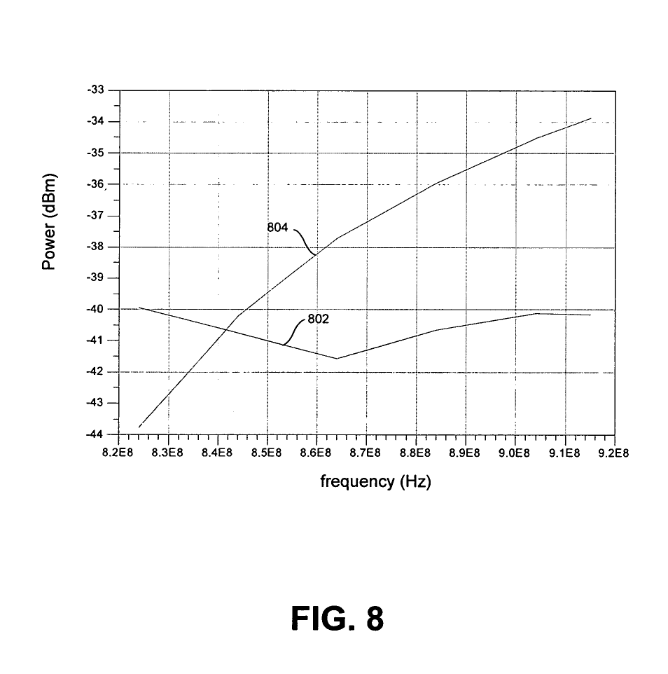

FIG. 8 is a graph showing second harmonic output power across a range of frequencies. For instance, the graph of FIG. 8 includes a curve 802 showing second harmonic output power for signal 522 of FIG. 5A when signal 520 has a power level of approximately 34 dBm. Additionally, the graph of FIG. 8 includes a curve 804 showing second harmonic output power for signal 526 of FIG. 5B when signal 524 has a power level of approximately 34 dBm. Curve 804 shows second harmonic levels that are lower than the isolated switch results of FIG. 4. More particularly, only a small portion of curve 804 is above −35 dBm.

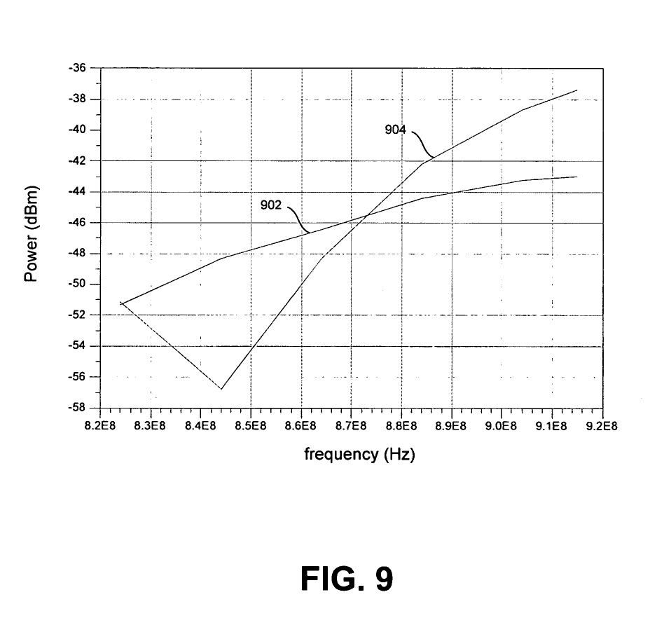

FIG. 9 is a graph showing third harmonic output power across a range of frequencies. This graph includes curves 902 and 904. Curve 902 shows third harmonic output power for signal 522 of FIG. 5A when signal 520 has a power level of 34 dBm. Similarly, curve 904 shows third harmonic output power for signal 526 of FIG. 5B when signal 524 has a power level of 34 dBm. Curve 904 shows third harmonic levels that are below −37 dBm.

Thus, the results of FIGS. 6-9 indicate that transmit arrangements can achieve acceptable performance results, even when employing switches that (in isolation) would conventionally be considered unsuitable.

While various embodiments of the present invention have been described above, it should be understood that they have been presented by way of example only, and not in limitation.

Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. An apparatus, comprising:
a filtering network to produce a filtered signal from an amplified signal, the filtered signal for wireless transmission in a frequency band;
a switch including a first terminal to receive the filtered signal, a second terminal, and a switching element to selectively couple the first and second terminals;
wherein the filtering network is to attenuate a plurality of harmonics of the filtered signal generated by the switch; and
wherein the attenuation establishes compliance with a harmonic emissions power limit associated with the frequency band by reducing at least one of the plurality of harmonics from a level exceeding the harmonic emissions power limit to a level within the harmonic emissions power limit.

2. The apparatus of claim 1, further comprising an antenna connected to the second terminal.

3. The apparatus of claim 1, wherein the frequency band includes at least one of the GSM 850, EGSM900, European DCS, or PCS frequency bands.

4. The apparatus of claim 1, wherein the switching element comprises a field effect transistor (FET).

5. The apparatus of claim 4, wherein the FET is a Gallium Arsenide (GaAs) pseudomorphic High Electron Mobility Transistor (pHEMT) FET.

6. The apparatus of claim 5, wherein the FET is less than or equal to approximately 2.1 millimeters in size.

7. The apparatus of claim 1, wherein the switching element comprises a diode.

8. The apparatus of claim 1, wherein the switching element comprises an electromechanical device.

9. The apparatus of claim 1, wherein the switch has a 1 dB compression point that is less than 6 dB above a maximum transmit power associated with the frequency band.

10. The apparatus of claim 1, wherein the switch has a 1 dB compression point less than 3 dB above a maximum transmit power level associated with the frequency band.

11. The apparatus of claim 1, wherein the switch has a 1 dB compression point less than 1 dB above a maximum transmit power level associated with the frequency band.

12. An apparatus, comprising:
a first filtering network to produce a first filtered signal from a first amplified signal, the first filtered signal for wireless transmission in a first cellular network;
a second filtering network to produce a second filtered signal from a second amplified signal, the second filtered signal for wireless transmission in a second cellular network;
an antenna; and
a switch to selectively provide the first filtered signal to the antenna, and to selectively provide the second filtered signal to the antenna.
wherein the first filtering network is to attenuate a plurality of harmonics of the first filtered signal generated by the switch, and is to establish compliance with a harmonic emissions power limit associated with the first frequency band; and
wherein the second filtering network is to attenuate a plurality of harmonics of the second filtered signal generated by the switch, and is to establish compliance with a harmonic emissions power limit associated with the second frequency band.

13. The apparatus of claim 12, wherein the first frequency band and the second frequency band are non-overlapping.

14. The apparatus of claim 13:
wherein the first frequency band comprises the GSM850 frequency band and the EGSM900 frequency band; and
wherein the second frequency band comprises the European DCS frequency band and the PCS frequency band.

15. The apparatus of claim 14, wherein the switch, when providing the first filtered signal to the antenna, exhibits a 1 dB compression point less than 6 dB above a maximum transmit power level associated with the first frequency band.

16. The apparatus of claim 14, wherein the switch, when providing the second filtered signal to the antenna, exhibits a 1 dB compression point less than 6 dB above a maximum transmit power level associated with the first frequency band.

17. The apparatus of claim 12, wherein the switch comprises:
a first field effect transistor (FET) to selectively provide the first filtered signal to the antenna; and
a second FET to selectively provide the second filtered signal to the antenna.

18. The apparatus of claim 12, wherein the switch comprises:
a first transmit switching element to selectively provide the first filtered signal to the antenna;
a second transmit switching element to selectively provide the second filtered signal to the antenna; and
one or more receive switching elements to selectively receive one or more signals from the antenna.

19. The apparatus of claim 12, wherein the first filtering network is to reduce at least one of the plurality of harmonics of the first filtered signal from a level exceeding the limit associated with the first frequency band to a level within the limit associated with the first frequency band.

20. The apparatus of claim 12, wherein the second filtering network is to reduce at least one of the plurality of harmonics of the second filtered signal from a level exceeding the limit associated with the second frequency band to a level within the limit associated with the second frequency band.
